(19) United States
(12) Patent Application Publication
(10) Pub. No.: US 2026/0369767 A1
(43) Pub. Date: Nov. 19, 2026

(54) BATTERY MODULE, BATTERY PACK, AND ELECTRICAL DEVICE

(71) Applicant: AESC Japan Ltd., Kanagawa (JP)

(72) Inventors: Xu Zhang, Shanghai (CN); Wenjia Zhang, Shanghai (CN); Fangkai Fu, Shanghai (CN); Yafei He, Shanghai (CN)

(73) Assignee: AESC Japan Ltd., Kanagawa (JP)

(21) Appl. No.: 19/675,393

(22) Filed: May 12, 2026

(30) Foreign Application Priority Data
May 16, 2025 (CN) 202520982412.3

(51) Int. Cl. H01M 50/211; B60L 50/60; B60L 50/64; H01M 10/42; H01M 50/249; H01M 50/296; H01M 50/507

(52) U.S. Cl. CPC H01M 50/211; B60L 50/64; B60L 50/66; H01M 10/425; H01M 50/249; H01M 50/296; H01M 50/507; H01M 2010/4271; H01M 2220/20

(57) ABSTRACT

Disclosed are a battery module, a battery pack, and an electrical device. The battery module includes: a plurality of cell stacks arranged along a first direction, each of the cell stacks including a plurality of cells stacked along a second direction; connection beams, disposed between two of the adjacent cell stacks; two side panel assemblies disposed, along the second direction, on both sides of the cell stacks, the side panel assemblies being connected to the connection beams to clamp and secure the cell stacks; and an electrical assembly, integrally fixed on the connection beams and/or the side panel assemblies. The cooperative connection between the side panel assemblies and the connecting beams enables installation and clamping of the cell stacks, thereby meeting transportation requirements, simplifying the structure, improving space utilization, and reducing cost.

### CROSS-REFERENCE TO RELATED APPLICATION

This application claims the priority benefit of China application serial no. 202520982412.3, filed on May 16, 2025. The entirety of the above-mentioned patent applications is hereby incorporated by reference herein and made a part of this specification.

### BACKGROUND

### Technical Field

The present disclosure pertains to the technical field of power batteries, and, in particular, to a battery module, a battery pack, and an electrical device.

### Description of Related Art

In conventional pouch battery pack designs, modules still serve as carriers for the cells. Multiple modules of the battery pack, together with electrical components such as the battery management system, must be secured in a mutually independent manner within the housing of the battery pack, which not only adversely affects production cycle time but also consumes substantial space, thereby compromising the energy density of the battery.

### SUMMARY

In view of the foregoing deficiencies of the related art, it is an object of the present disclosure to provide a battery module, a battery pack, and an electrical device, configured to address the issues of low space utilization and low production efficiency in the related art, thereby improving energy density of batteries and reducing costs.

To achieve the foregoing and other related objectives, the present disclosure provides a battery module, including:
A plurality of cell stacks, the plurality of cell stacks being arranged along a first direction, each of the cell stacks including a plurality of cells stacked along a second direction;
Connection beams, any two of the cell stacks adjacent to each other being provided with one of the connection beams;
Two side panel assemblies, the two side panel assemblies being disposed, along the second direction, on both sides of the cell stacks, the side panel assemblies being connected to the connection beams to clamp and secure the cell stacks;
An electrical assembly, integrally fixed on at least one kind of the connection beams and/or the side panel assemblies.

Optionally, each of the side panel assemblies includes a plurality of side panel segments distributed along the first direction and detachably connected. The side panel segments located on both sides of the same cell stack are detachably connected, respectively, to both ends of the corresponding connection beams.

Optionally, the plurality of side panel segments of the same side panel assembly correspond to the plurality of cell stacks one by one. The two side panel segments located on both sides of the cell stack, when connected to the connection beams, clamp and secure the cell stack along the second direction.

Optionally, each of the side panel segments has a first connection portion. Two of the adjacent first connection portions of two of the adjacent side panel segments in the same side panel assembly are stacked along the second direction and are connected to and tightly engaged with the connection beams.

Optionally, one of the two first connection portions that are stacked has a cross-section that is L-shaped, and the other one of the first connection portions has a cross-section that is an inverted L-shape that is complementary to and in surface contact with the L-shaped structure.

Optionally, the electrical assembly includes a battery management system and sampling elements. The battery management system includes a plurality of slave panels. The plurality of slave panels are mounted and fixed on the side panel assemblies and are electrically connected, respectively, to the plurality of cell stacks via the sampling elements.

Optionally, each of the side panel assemblies includes a plurality of side panel segments distributed along the first direction and detachably connected. The plurality of side panel segments within the same side panel assembly respectively correspond to the cell stacks one by one. The slave panel is mounted on each of the side panel segments, and the slave panel is electrically connected to the corresponding cell stack via the sampling element.

Optionally, a groove is provided on the side panel assembly. The slave panel is mounted within the groove, and an outer wall of the slave panel is lower than, or aligned with, an opening of the groove.

Optionally, the groove is provided on the exterior of the side panel assembly facing away from the cell stack, and extends along a third direction so as to run through a top end of the side panel assembly. A top end of the slave panel does not protrude beyond the top end of the side panel assembly, and a side wall of the slave panel does not protrude beyond an outer side wall of the side panel assembly.

Optionally, the slave panel is fixed on the side panel assembly by snap-fit engagement or by bolted connection.

Optionally, some of the two cell stacks adjacent to each other are provided with first connection terminal tabs. The electrical assembly includes a bridging busbar and a first connection busbar. The first connection busbar is connected to the first connection terminal tab. The first connection busbars respectively connected to the corresponding first connection terminal tabs of the two cell stacks adjacent to each other are offset in projection along the first direction, and are interconnected by the bridging busbar and fixed on the connection beam.

Optionally, some of the cell stacks are provided with low-voltage output terminal tabs. The electrical assembly includes a low-voltage busbar bracket and a low-voltage output busbar. The low-voltage busbar bracket is positioned and assembled on the side panel assembly, and the low-voltage output busbar is mounted on the low-voltage busbar bracket and connected to one of the low-voltage output terminal tabs.

Optionally, some of the cell stacks are provided with high-voltage output terminal tabs. The electrical assembly includes a high-voltage busbar bracket and a high-voltage output busbar. The high-voltage output busbar is mounted on the high-voltage busbar bracket, and a connection end of the high-voltage output busbar is connected to the corresponding one of the high-voltage output terminal tabs.

Optionally, the low-voltage output busbar and the high-voltage output busbar are respectively disposed on both sides of the battery module in the first direction. The high-voltage output busbar is adapted to output a high voltage and the low-voltage output busbar is adapted to output a low voltage.

Optionally, the connection beam formed as an end beam is disposed on a side of the cell stack located at an edge side that is away from a cell stack adjacent thereto. The connection beam is connected to an end portion of the side panel assembly. The high-voltage output busbar and the low-voltage output busbar are respectively connected to, and electrically insulated from, two of the connection beams on both sides.

Optionally, some of the two cell stacks adjacent to each other are provided with second connection terminal tabs. The electrical assembly includes a first bracket and a second connection busbar, and the first bracket is positioned and mounted on the side panel assembly. The second connection busbar is mounted on the first bracket and connected to the second connection terminal tab, and the second connection busbar is connected to another one of the second connection busbar that is connected to an adjacent one of the cell stacks.

Optionally, some of the two cell stacks adjacent to each other are provided with third connection terminal tabs. The electrical assembly includes a second bracket and a third connection busbar, and the second bracket is located between the cell stack and the connection beam and mounted on the connection beam. The third connection busbar is secured on the second bracket and connected to the third connection terminal tab, and the third connection busbar is connected to another one of the third connection busbar that is connected to an adjacent one of the cell stacks.

Optionally, the cell includes a pouch cell.

Optionally, the connection beam formed as an end beam is disposed on a side of the cell stack located at the edge side that is away from the cell stack adjacent thereto. End portions of the two side panel assemblies are connected to each other via the end beam; and/or, the end portions of the two side panel assemblies are wrapped and fastened together by a strap.

To achieve the foregoing and other related objects, the present disclosure further provides a battery pack including the battery module as described above and a plate-shaped lower casing. The side panel assembly is connected to the lower casing to mount the cell stack on the lower casing.

Optionally, the battery pack further includes an upper lid. The upper lid is connected to the lower casing in a sealed manner to define a mounting space accommodating the cell stack, and the mounting space is filled with a coolant that submerges the cell stack.

Optionally, a portion of the lower casing is raised in a direction facing away from the battery module to form an accommodating cavity, and the battery module is mounted in the accommodating cavity.

To achieve the foregoing and other related objects, the present disclosure further provides an electrical device including the battery module as described above.

Optionally, the electrical device includes a vehicle, wherein a bottom portion of the vehicle has the mounting space, and the battery module is mounted within the mounting space.

As set forth above, the battery module, battery pack, and the electrical device of the present disclosure have at least the following advantageous effects: the side panel assembly cooperates with the connection beam to mount and clamp the cell stack, thereby satisfying transportation requirements while simplifying the structure, which facilitates improved space utilization and cost reduction. On basis of the above, electrical components are integrally fixed on the connection beam and/or the side panel assembly without separate fixation, reducing the number of parts, increasing the degree of integration, simplifying subsequent installation steps, and contributing to improvements in the energy density and production efficiency of the battery pack.

### BRIEF DESCRIPTION OF THE DRAWINGS

FIG. 1 is a schematic structural view of a first embodiment of a battery module of the present disclosure.

FIG. 2 is an exploded view of the battery module shown in FIG. 1.

FIG. 3 is a schematic structural view of a second embodiment of the battery module of the present disclosure.

FIG. 4 is an exploded view of the battery module shown in FIG. 3.

FIG. 5 is a partial structural view of the battery module shown in FIG. 3.

FIG. 6 is a top view of the battery module of FIG. 5.

FIG. 7 is an enlarged view of a portion A in FIG. 6.

FIG. 8 is a partial exploded view of a first bracket, a second connection busbar, a side panel assembly, and a connection beam in FIG. 7.

FIG. 9 is an enlarged view of a portion B in FIG. 6.

FIG. 10 is a schematic view of a partial structural connection between a bridging busbar and a first connection busbar in FIG. 9.

FIG. 11 is a partial exploded view of the bridging busbar and the first connection busbar in FIG. 9.

FIG. 12 is an enlarged view of a portion C in FIG. 6.

FIG. 13 is a schematic view of a partial structural connection between a low-voltage busbar bracket and a low-voltage output busbar in FIG. 12.

FIG. 14 is a partial exploded view of the low-voltage busbar bracket and the low-voltage output busbar in FIG. 12.

FIG. 15 is a simplified partial structural view of the battery module shown in FIG. 3.

FIG. 16 is an enlarged view of a portion D in FIG. 6.

FIG. 17 is a schematic view of a partial connection structure of a second bracket, a third connection busbar, and a connection beam in a third embodiment of the battery module of the present disclosure.

FIG. 18 is a partial exploded view of the first bracket, the second connection busbar, and the connection beam of the battery module in FIG. 17.

FIG. 19 is a schematic structural view of an embodiment of a battery pack of the present disclosure.

FIG. 20 is a partial exploded view of the battery pack shown in FIG. 19.

FIG. 21 is a simplified schematic structural view of an embodiment of an electrical device of the present disclosure.

### DESCRIPTION OF THE EMBODIMENTS

The embodiments of the present disclosure are described below by way of specific exemplary embodiments. From the contents disclosed herein, persons skilled in the art will readily understand other advantages and effects of the present disclosure.

It should be understood that the structures, proportions, dimensions, and the like depicted in the accompanying drawings of this specification are provided solely to facilitate the understanding and reading of the disclosure by those skilled in the art, and are not intended to define limiting conditions under which the present disclosure may be practiced, and therefore are not of substantive technical significance. Any modification of structures, changes in proportional relationships, or adjustments in dimensions, provided they do not affect the efficacy or the objectives achievable by the present disclosure, shall be deemed to fall within the scope encompassed by the technical content disclosed herein. Moreover, the terms “upper,” “lower,” “left,” “right,” “middle,” and “one,” as used in this specification, are employed solely for clarity of description and are not intended to limit the scope in which the present disclosure may be implemented. Changes or adjustments to their relative relationships, without any substantive alteration of the technical content, shall likewise be regarded as falling within the scope of implementation of the present disclosure.

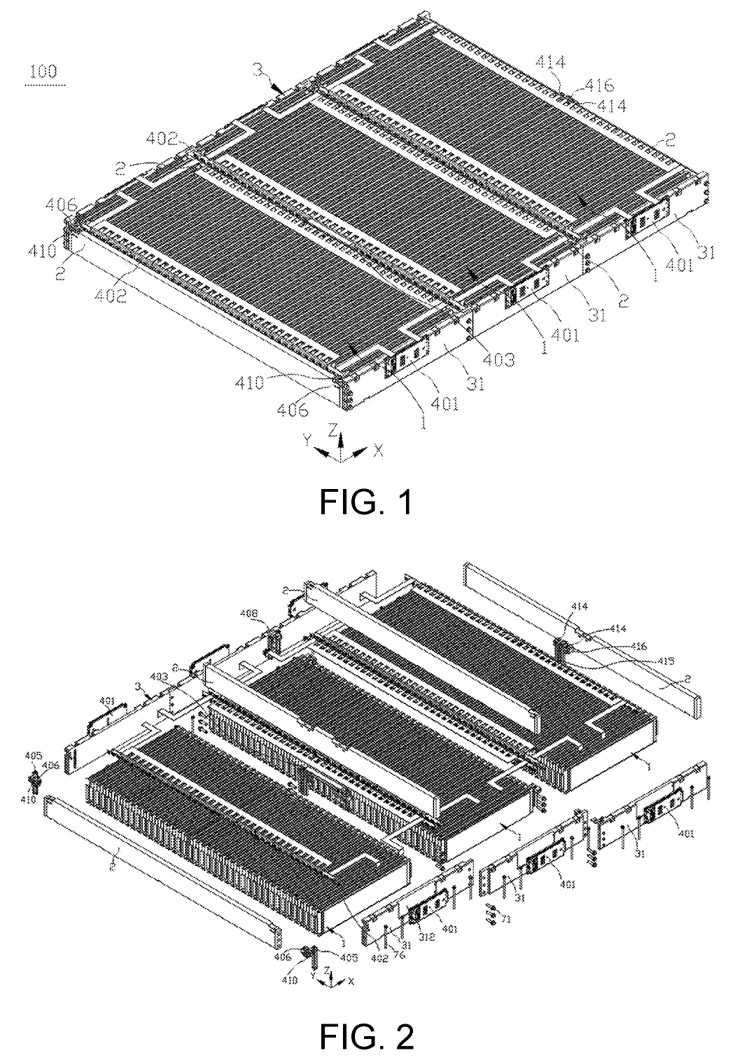

Referring to FIGS. 1-4, in some optional embodiments, the present disclosure provides a battery module 100, which includes a plurality of cell stacks 1, connection beams 2, two side panel assemblies 3, and an electrical assembly. The plurality of cell stacks 1 are arranged in a first direction. Each of the cell stacks 1 includes a plurality of cells 11 stacked in a second direction, the cells 11 including pouch cells. Any two of the cell stacks 1 adjacent to each other are provided with one of the connection beams 2. The two side panel assemblies 3 are disposed on both sides of the cell stacks 1 in the second direction. The side panel assemblies 3 are connected with the connection beams 2 to clamp and secure the cell stacks 1, and the electrical assembly is integrally fixed on the connection beams 2 and/or the side panel assemblies 3.

Optionally, a plurality of the connection beams 2 may be provided, and the plurality of connection beams 2 are distributed along the first direction.

In the foregoing embodiments of the battery module, a frame formed by the cooperative connection of the side panel assemblies 3 and the connection beams 2 enables installation and clamping of the cell stacks 1 to meet transportation requirements. The electrical assembly is integrally fixed on the frame formed by the side panel assemblies 3 and the connection beams 2 without separate installation and fixation, i.e., without the need to provide a separate fixing bracket, which is conducive to simplifying the structure, improving space utilization and energy density, reducing manufacturing steps, and lowering costs. Specifically, upon completion of assembly, the battery module may constitute a battery device without a housing, so that the battery device may be directly installed and used subsequently, for example, directly installed in a mounting space of a battery pack or in a mounting space of an electrical device.

Referring to FIGS. 1 and 2, in some optional embodiments, in the first direction, both sides of the battery module 100 are also provided with connection beams corresponding to end portions of the side panel assemblies 3. That is, the connection beam 2 formed as an end beam is also disposed on a side of the cell stack 1 located at an edge side that is away from a cell stack 1 adjacent thereto. The end beam corresponds to and is connected with an end portion of the side panel assembly 3. The connection beam 2 located between the two cell stacks 1 adjacent to each other is formed as an intermediate beam. The end portions of the two side panel assemblies 3 are connected via the end beam, thereby further enhancing the clamping stability of the corresponding cell stack 1 and the rigidity of the overall structure.

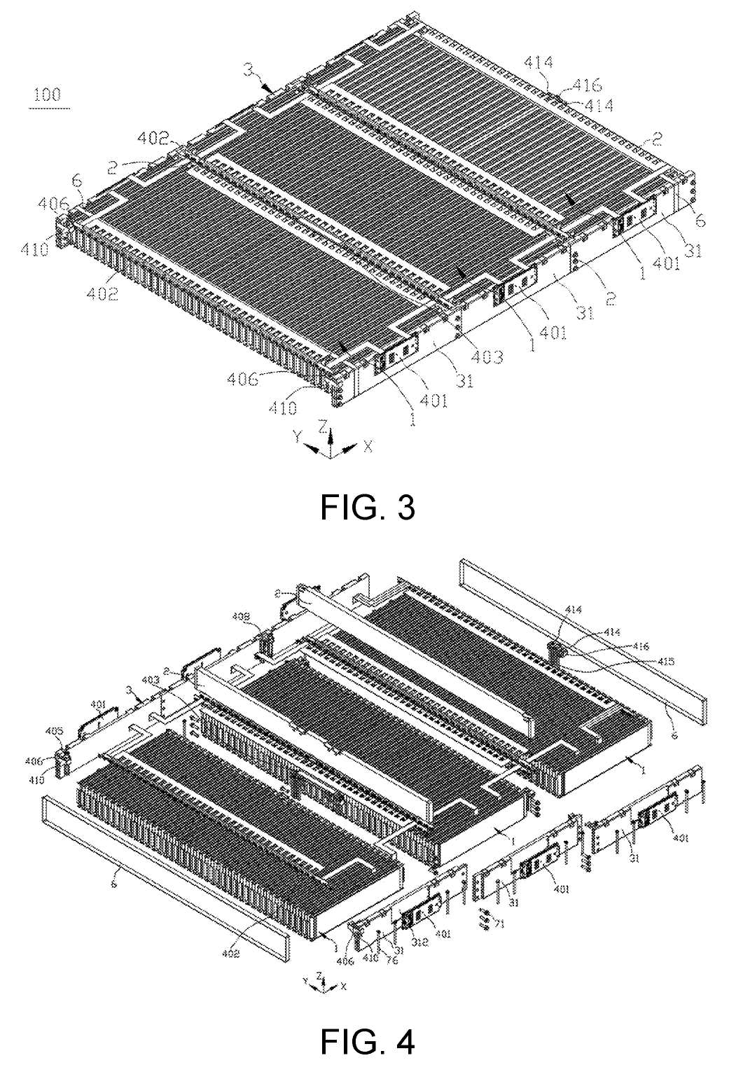

With reference to FIGS. 3 and 4, in some optional embodiments, in the first direction, the end portions of the two side panel assemblies 3 are wound and fastened together by a strap 6. Specifically, the strap 6 is disposed corresponding to the end portions of the side panel assemblies 3, and the strap 6 is sleeved over the end portions of the two side panel assemblies 3 so that the two side panel assemblies 3 are urged toward one another to clamp the corresponding cell stack 1. An end beam need not be provided while ensuring the stability of the clamping of the cell stack 1. The strap 6 occupies less space and has a lower mass than an end beam, which is advantageous for improving space utilization and increasing the energy density of the battery module.

It will be understood that the end portions of the two side panel assemblies 3 may be connected solely by an end beam; alternatively, the end portions of the two side panel assemblies 3 may be wound and fastened solely by the strap 6; or the end portions of the two side panel assemblies 3 may be connected by an end beam and, in addition, wound and fastened by the strap 6, thereby further enhancing the stability of the overall structure.

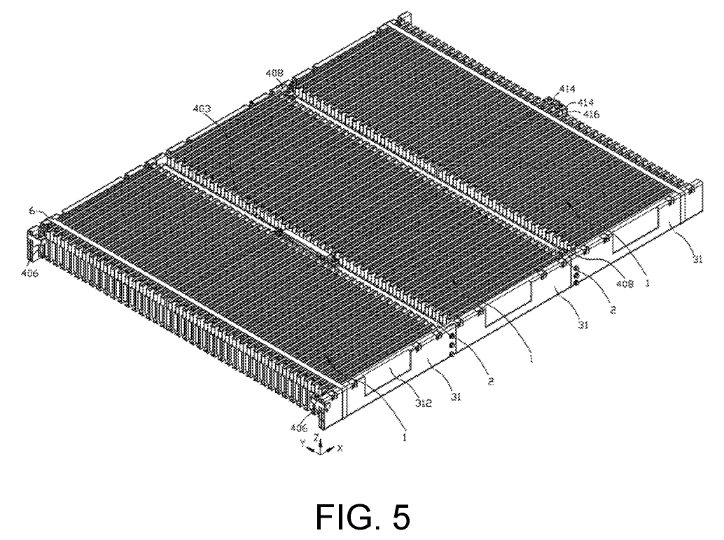

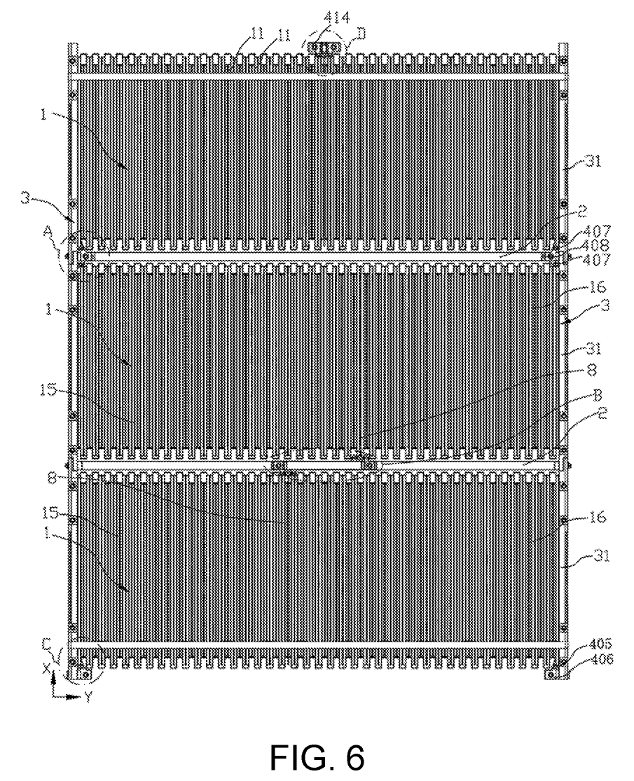

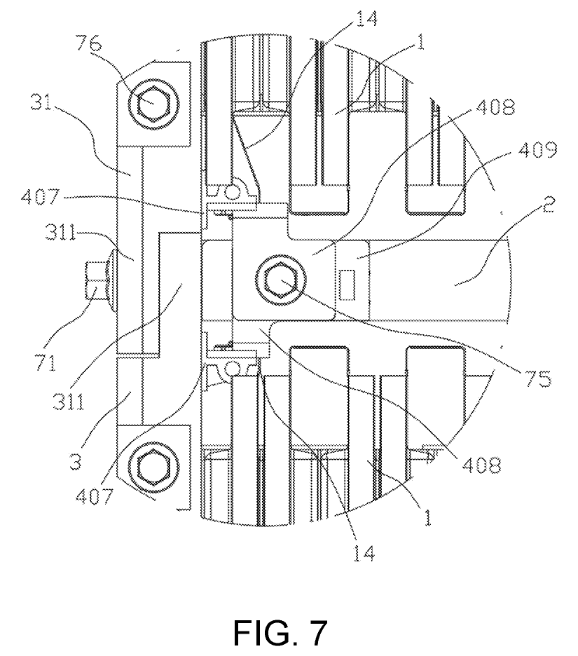

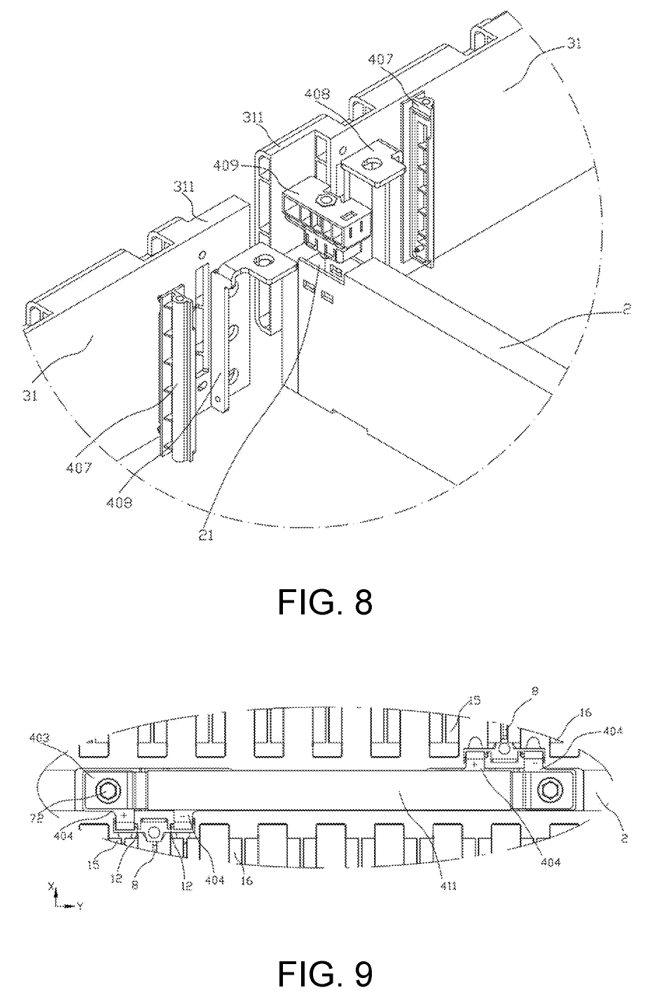

With reference to FIGS. 3-8, in some optional embodiments, each of the side panel assemblies 3 includes a plurality of side panel segments 31 that are distributed along the first direction and are detachably connected. The side panel segments 31 located on both sides of the same cell stack 1 are detachably connected, respectively, to both ends extending in a second direction of a corresponding connection beam 2.

Optionally, the side panel segment 31 and the connection beam 2 may be connected and tightly engaged by a first locking member 71. The first locking member 71 includes a bolt, thereby providing a reliable connection and enabling simple and convenient assembly and disassembly.

Optionally, the multiple side panel segments 31 within the same side panel assembly 3 correspond to the multiple cell stacks 1 one by one. Two side panel segments 31 disposed on the both sides of the cell stack 1, when connected to the connection beams 2, clamp and fix the cell stack 1 along the second direction. Assembly is simple and flexible, and the number of the side panel segments 31 within the side panel assembly 3 may be increased or decreased according to the required number of the cell stacks 1, so as to meet different capacity requirements and facilitate a standardized/universal configuration.

Optionally, the side panel segment 31 includes a first connection portion 311. Two of the adjacent first connection portions 311 of the two side panel segments 31 that are adjacent within the same side panel assembly 3 are overlapped along the second direction and are connected and tightly engaged to the connection beams 2. Specifically, one end of the first locking member 71 passes, along the second direction, through the first connection portions 311 of the two side panel segments 31 adjacent to each other and is then threadedly connected to the connection beam 2. Further, one of the two overlapped first connection portions 311 has a cross-section that is L-shaped, and the other first connection portion 311 has a cross-section that is an inverted L-shape that is complementary to and in surface contact with the L-shaped structure. The side panel segment 31 may be an aluminum material, an injection-molded member, or a die-cast member.

In the present disclosure, the first direction is perpendicular to the second direction. An arrangement direction of the plurality of cell stacks 1, an arrangement direction of the plurality of side panel segments 31 in each of the side panel assemblies 3, a length direction of each of the side panel segments 31, an arrangement direction of the plurality of connection beams 2, a length direction of the cell stack 1, and a length direction of the cell 11 are the same as the first direction, namely the direction X in the drawings. An arrangement direction of the plurality of cells 11 in each of the cell stacks 1, an arrangement direction of the two side panel assemblies 3, a length direction of the connection beam 2, a width direction of the cell stack 1, and a thickness direction of the cell 11 are the same as the second direction, namely the direction Y in the drawings.

In the battery module in the foregoing embodiments, the side panel assembly 3 includes a plurality of independently provided side panel segments 31. The side panel segments 31 are detachably connectable to each other, and the side panel segments 31 are also detachably connectable to the connection beams 2, thereby facilitating flexible assembly according to the number of cell stacks 1, avoiding waste of space, improving space utilization, and further reducing cost. In addition, the plurality of cell stacks 1 may be connected and combined into an integral structure through the side panel assembly 3 and the connection beam 2, which both eliminates the process of separately boxing each of the cell stacks 1 and improves the overall structural rigidity of the battery module.

Referring to FIGS. 3-5, in some optional embodiments, the electrical assembly includes a battery management system and sampling elements 402. The battery management system includes a plurality of slave panels 401, and the plurality of slave panels 401 are mounted and secured to the side panel assembly 3 and are respectively electrically connected to the plurality of cell stacks 1 via the sampling elements 402.

Optionally, the battery management system further includes a master control panel. The slave panel 401 is connected to the cell stack 1 via the sampling element 402. The sampling element 402 includes a flexible printed circuit (FPC). The master control panel is connected to the plurality of slave panels 401. Furthermore, the slave panel 401 is mounted on each of the side panel segments 31. The slave panel 401 may be connected to the corresponding cell stack 1 via the sampling element 402 to acquire voltage signals of cells 11 within the cell stack 1 through the sampling element 402. The master control panel performs diagnosis and control of respective cells 11 via the plurality of slave panels 401.

Optionally, a recess 312 is provided on the side panel assembly 3, and the slave panel 401 is mounted within the recess 312, with an outer wall of the slave panel 401 being lower than, or aligned with, an opening of the recess 312. The slave panel 401 is simple and convenient to install; during transportation, the side panel assembly 3 is subjected to extrusion prior to the slave panel 401, thereby providing protection to the slave panel 401 and reducing the risk of the slave panel 401 being subjected to compressive loading. Furthermore, the recess 312 is disposed on the exterior of the side panel assembly 3 facing away from the cell stack 1 and extends in a third direction through a top end of the side panel assembly 3. A top end of the slave panel 401 does not protrude beyond the top end of the side panel assembly 3, and a side wall of the slave panel 401 does not protrude beyond an outer side wall of the side panel assembly 3.

Optionally, the slave panel 401 is fixed on the side panel assembly 3 by snap-fit engagement or by a bolted connection, facilitating simple and convenient attachment.

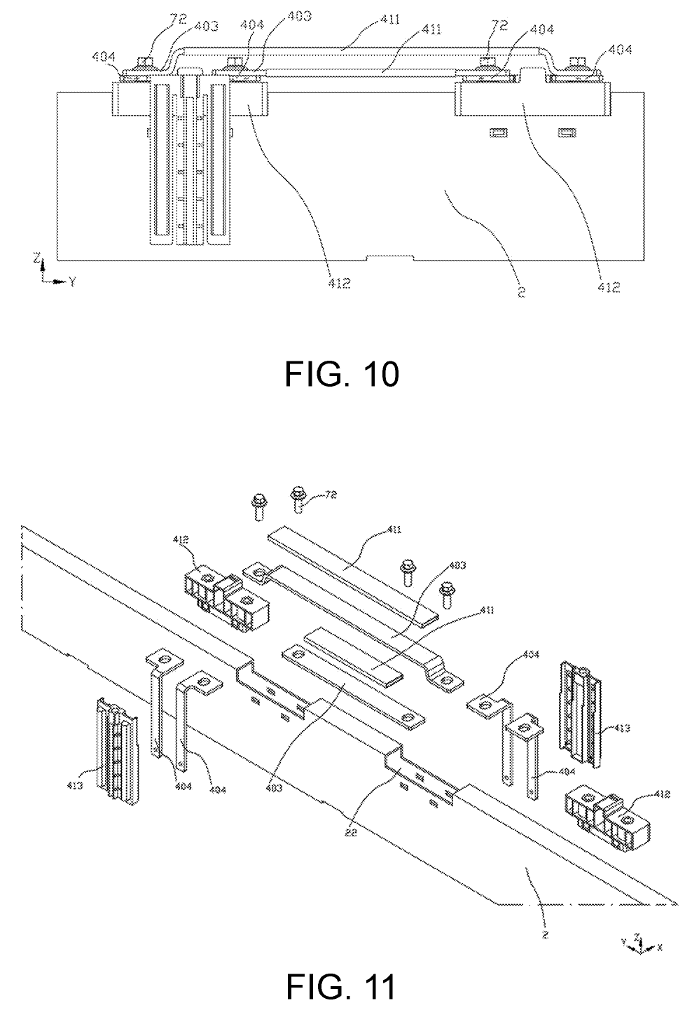

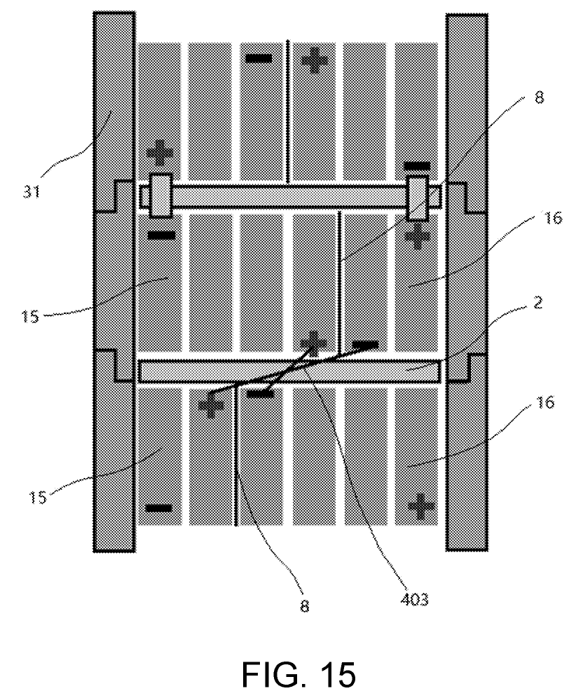

Referring to FIGS. 3-6, 9-11, and 15, in some optional embodiments, some of the two cell stacks 1 adjacent to each other are provided with first connection terminal tabs 12. The electrical assembly includes a bridging busbar 403 and a first connection busbar 404. The first connection busbar 404 is connected to a first connection terminal tab 12, and the first connection busbars 404 respectively connected to the first connection terminal tabs 12 of the two cell stacks 1 adjacent to each other are offset in projection along the first direction, and are interconnected by the bridging busbar 403 and fixed on the connection beam 2.

Optionally, the first connection busbar 404 includes a copper busbar.

Optionally, the bridging busbar 403 includes a copper busbar.

Optionally, within the same cell stack 1, a portion of the cells 11 constitutes a first sub-stack 15, and another portion of the cells 11 constitutes a second sub-stack 16. The first sub-stacks 15 of the two cell stacks 1 adjacent to each other are disposed proximate to the same side panel assembly 3, and the second sub-stacks 16 of the two cell stacks 1 adjacent to each other are disposed proximate to the other side panel assembly 3. In other words, the arrangement directions of the first sub-stack 15 and the second sub-stack 16 of the two cell stacks 1 adjacent to each other are the same in the second direction. For example, the first sub-stack 15 and the second sub-stack 16 of the two cell stacks 1 adjacent to each other are each arranged sequentially from left to right in the second direction, or each arranged sequentially from right to left. The first connection terminal tab 12 includes a first tab of the first sub-stack 15 and a second tab of the second sub-stack 16. The first connection busbar 404 connected to the first tab and the first connection busbar 404 connected to the second tab of an adjacent cell stack 1 are interconnected by one bridging busbar 403, and the first connection busbar 404 connected to the second tab and the first connection busbar 404 connected to the first tab of an adjacent cell stack 1 are interconnected by another bridging busbar 403. Further, the respective numbers of cells 11 in the first sub-stacks 15 of the two cell stacks 1 adjacent to each other are unequal, and the respective numbers of cells 11 in the second sub-stacks 16 of the two cell stacks 1 adjacent to each other are unequal. Specifically, the total number of cells 11 in each cell stack 1 is equal. If the number of cells 11 in the first sub-stack 15 is greater than the number of cells 11 in the first sub-stack 15 of an adjacent cell stack 1, then the number of cells 11 in the second sub-stack 16 is less than the number of cells 11 in the second sub-stack 16 of the adjacent cell stack 1. Alternatively, if the number of cells 11 in the first sub-stack 15 is less than the number of cells 11 in the first sub-stack 15 of the adjacent cell stack 1, then the number of cells 11 in the second sub-stack 16 is greater than the number of cells 11 in the second sub-stack 16 of the adjacent cell stack 1. By adjusting the numbers of cells 11 in the first sub-stacks 15 and the second sub-stacks 16 of adjacent cell stacks 1, the first connection busbars 404 corresponding to and connected with the respective sub-stacks are caused to be offset in projection along the first direction, i.e., the first connection busbars 404 corresponding to and connected with the respective sub-stacks may be spaced apart in the second direction, with high flexibility in adjusting the interval distance, thereby enabling a staggered overlapping connection between two first connection terminal tabs 12 by means of the bridging busbars 403. Such configuration is conducive to increasing a creepage distance during connection of the respective sub-stacks and, in particular, as compared with a layout in which the first connection terminal tabs 12 of the two cell stacks 1 adjacent to each other are disposed directly opposite one another in the first direction and directly connected, increases the creepage distance when connecting the adjacent cell stacks 1 and improves electrical safety.

Optionally, the first tab and the second tab connected by the same bridging busbar 403 are of opposite polarities, and a portion between both ends of one of the bridging busbars 403 extends along the second direction across the other bridging busbar 403 and is spaced from the other bridging busbar 403 in the third direction. By suitably assigning the positive and negative polarities of the cells 11, the bridging busbar 403 may both connect the two sub-stacks of the two cell stacks 1 adjacent to each other in series and avoid crossing contact with the other bridging busbar 403, resulting in a compact layout conducive to improved space utilization. Further, the portion between the both ends of the bridging busbar 403 constitutes a spanning portion that is covered with an insulating sleeve 411 to facilitate insulation. Specifically, one bridging busbar 403 is Ω-shaped, and the other bridging busbar 403 is linear; the Ω-shaped bridging busbar 403 spans, in the second direction, across the linear bridging busbar 403.

Optionally, an insulating partition 8 is disposed between the first sub-stack 15 and the second sub-stack 16 of the same cell stack 1. Alternatively, the insulating partition 8 is provided between some of the adjacent cells 11 of the same cell stack 1. The first connection busbar 404 is mounted on the insulating partition 8 via a third bracket 413. The third bracket 413 includes a plastic bracket. The first connection busbar 404 may be riveted to and fixed on the third bracket 413. The material of the first connection terminal tab 12 is relatively soft and therefore cannot readily provide a stable mounting support for the first connection busbar 404. The insulating partition 8, through the third bracket 413, may provide mounting support for the first connection busbar 404, rendering the first connection busbar 404 less susceptible to wobble and facilitating a reduction in the difficulty of connecting the first connection busbar 404 to the bridging busbar 403. In particular, on both sides in the second direction, the insulating partition 8 is adhesively bonded and fixed respectively on the cells 11 of the first sub-stack 15 and the cells 11 of the second sub-stack 16 of the same cell stack 1. Further, in the first direction, a length of the insulating partition 8 is not less than a length of an insulation film of the cell 11. In the third direction, a width of the insulating partition 8 is not less than a maximum width of a stacked electrode assembly of the cell 11, which is conducive to ensuring insulation performance.

Optionally, a height direction of the connection beam 2 is the third direction. In the third direction, the top of the connection beam 2 is lower than the top of the cell stack 1. The bridging busbar 403 is fixed on the top of the connection beam 2, and the bridging busbar 403 is fixed on the top of the connection beam 2 via a bridging base 412. By fixing the bridging busbar 403 on the connection beam 2, a free space above the connection beam 2 may be utilized to improve space utilization, and no additional components are required to provide support for the bridging busbar 403, thereby reducing the number of parts, simplifying the structure, and further improving space utilization. Further, the bridging base 412 is mounted on the connection beam 2. The first connection busbar 404 is connected to the bridging busbar 403 and is connected and fixed on the bridging base 412. Specifically, a second mounting groove 22 is provided at the top of the connection beam 2. At least a portion of the bridging base 412 extends into the second mounting groove 22 and is snap-fitted and fixed in engagement with the second mounting groove 22. One end of the first connection busbar 404 is electrically connected to the first connection terminal tab 12 of the cell stack 1. The other end of the first connection busbar 404 is bent and stacked with one end of the bridging busbar 403 along the third direction on the bridging base 412, and is connected and fixed by a second locking member 72. The second locking member 72 includes a bolt, thereby providing a simple, convenient, and reliable connection.

In the present disclosure, a height direction of the cell stack 1, a height direction of the connection beam 2, a height direction of the side panel assembly 3, a height direction of the side panel segment 31, and a height direction of the cell 11 are the same as the third direction, i.e., the direction Z as shown in the drawings.

In the battery module according to the foregoing embodiment, the plurality of first connection busbars 404 respectively connected to the first connection terminal tabs 12 of the adjacent cell stacks 1 are offset in projection in the first direction, and are electrically connected via the bridging busbar 403. This design not only enables serial and/or parallel interconnection of the adjacent cell stacks 1, but also facilitates an increase in the creepage distance between the two first connection terminal tabs 12 during electrical connection, thereby reducing the probability of electrical safety incidents and improving the safety performance of the battery module.

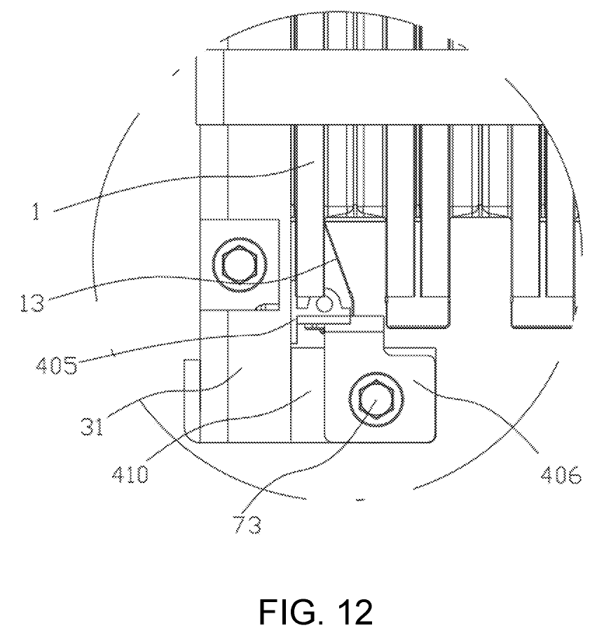

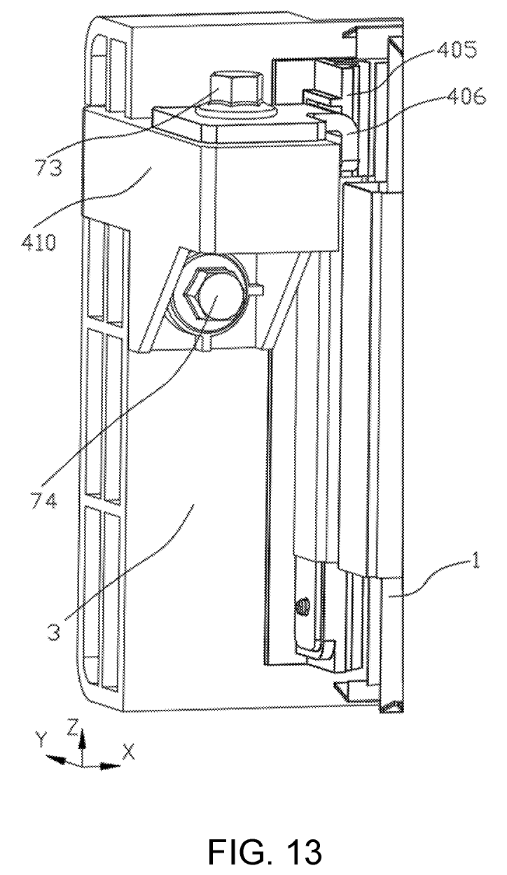

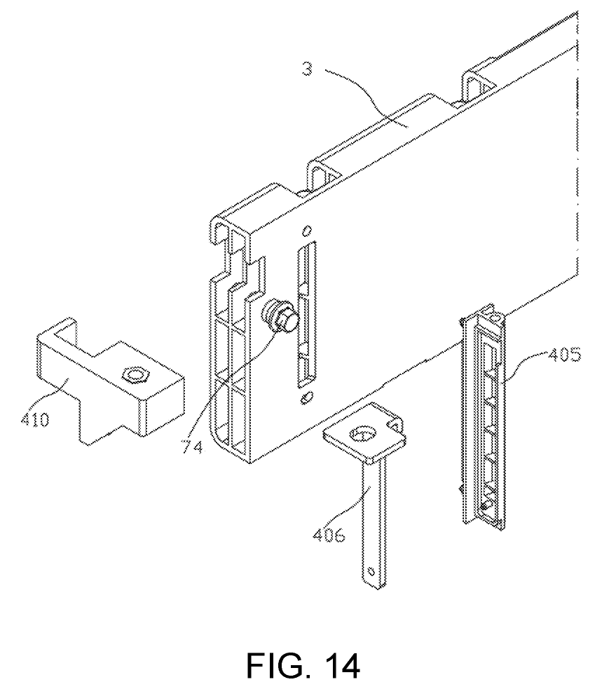

Referring to FIGS. 3-6 and 12-14, in some optional embodiments, some of the cell stacks 1 are provided with low-voltage output terminal tabs 13. The electrical assembly includes a low-voltage busbar bracket 405 and a low-voltage output busbar 406. The low-voltage busbar bracket 405 is positioned and mounted on the side panel assembly 3, the low-voltage output busbar 406 is mounted on the low-voltage busbar bracket 405, and a connection end of the low-voltage output busbar 406 is connected to the low-voltage output terminal tab 13.

Optionally, the electrical assembly further includes a low-voltage output terminal base 410. The low-voltage output terminal base 410 is mounted on the side panel segment 31 of the side panel assembly 3. The low-voltage busbar bracket 405 is positioned and mounted on the side panel segment 31. The low-voltage output busbar 406 connected to the low-voltage output terminal tab 13 is connected and fixed on the low-voltage output terminal base 410 by a third locking member 73. An output end of the low-voltage output busbar 406 is connected and fixed on the low-voltage output terminal base 410 via the third locking member 73. The third locking member 73 includes a bolt, making the connection simple, convenient, and reliable. Further, the low-voltage output terminal base 410 is locked and fixed on the side panel segment 31 by a fourth locking member 74. The fourth locking member 74 includes a bolt.

Optionally, the low-voltage output busbar 406 includes a copper busbar.

Optionally, the low-voltage busbar bracket 405 includes a plastic bracket.

Optionally, the low-voltage busbar bracket 405 is fixed on the side panel segment 31 in an embedded and/or riveted manner, providing a simple, convenient, and reliable connection.

Specifically, during assembly, the low-voltage output terminal base 410 is first fixed on the side panel segment 31, and the low-voltage output busbar 406 is fixed on the side panel segment 31 via the low-voltage busbar bracket 405. The side panel segment 31 is assembled and connected with the connection beam 2 in the second direction. After assembly is completed, the low-voltage output busbar 406 is then welded and fixed on the low-voltage output terminal tab 13 of the cell stack 1 and connected and fixed on the low-voltage output terminal base 410. The low-voltage output busbar 406, which is supported and fixed by the side panel segment 31, is connected to the low-voltage output terminal base 410, which is likewise supported and fixed by the side panel segment 31, such that both the low-voltage output terminal base 410 and the low-voltage output busbar 406 are not prone to wobbling or positional deviation, thereby ensuring stability when the low-voltage output busbar 406 and the low-voltage output terminal base 410 are connected by the third locking member 73.

In the foregoing embodiments of the battery module, the low-voltage output terminal base 410 and the low-voltage busbar bracket 405 connected to the low-voltage output busbar 406 are fixed on the side panel segment 31. The side panel segment 31 provides support for the low-voltage output terminal base 410 and the low-voltage busbar bracket 405, so that the low-voltage output terminal base 410 and the low-voltage output busbar 406 are less prone to positional deviation, thereby ensuring structural stability and facilitating external output of the cell stack 1.

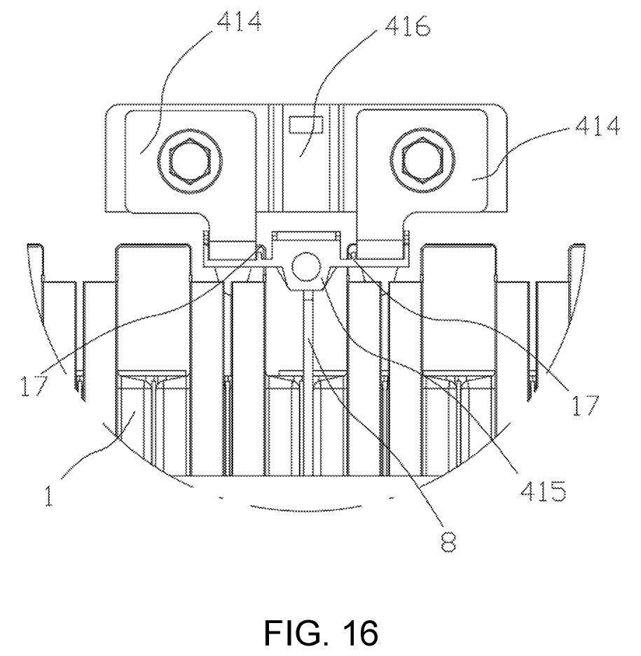

Referring to FIGS. 1-6 and 16, in some optional embodiments, a portion of the cell stack 1 is provided with a high-voltage output terminal tab 17, and the electrical assembly includes a high-voltage busbar bracket 415 and a high-voltage output busbar 414. The high-voltage output busbar 414 is mounted on the high-voltage busbar bracket 415, and a connection end of the high-voltage output busbar 414 is connected to the high-voltage output terminal tab 17.

Optionally, the low-voltage output busbar 406 and the high-voltage output busbar 414 are respectively located on both sides of the battery module in the first direction. The high-voltage output busbar 414 is adapted to output a high voltage, and the low-voltage output busbar 406 is adapted to output a low voltage. Accordingly, the same battery module may output both a high voltage and a low voltage, thereby satisfying different conditions, enabling a more compact layout, improving space utilization, and reducing cost.

Referring to FIGS. 1 and 2, the connection beam 2 formed as an end beam is disposed on a side of the cell stack 1 located at an edge side that is away from the cell stack adjacent thereto. The connection beam 2 is connected to an end portion of the side panel assembly 3. The high-voltage output busbar 414 and the low-voltage output busbar 406 are respectively connected, in an electrically insulated manner, to two of the connection beams 2 on both sides.

Optionally, referring to FIGS. 1 and 2, an output end of the high-voltage output busbar 414 is connected to the connection beam 2 in an electrically insulated manner. Further, the electrical assembly further includes a high-voltage output terminal base 416, and the output end of the high-voltage output busbar 414 is connected to the connection beam 2 in an electrically insulated manner via the high-voltage output terminal base 416. Specifically, the high-voltage output terminal base 416 is mounted on the connection beam 2, and the output end of the high-voltage output busbar 414 is connected and fixed on the high-voltage output terminal base 416 by bolts. The output end of the low-voltage output busbar 406 is connected to the connection beam 2 in an electrically insulated manner. Further, the output end of the low-voltage output busbar 406 is connected to the connection beam 2 in an electrically insulated manner via the low-voltage output terminal base 410.

Optionally, in a region of the cell stack 1 provided with the high-voltage output terminal tab 17, the insulating partition 8 is disposed between two cells 11 adjacent to each other. A portion of the insulating partition 8 is clamped and fixed between two cells 11 adjacent to each other within the same cell stack 1, and another portion of the insulating partition 8 protrudes between the adjacent cells 11. The high-voltage busbar bracket 415 is fitted and connected with the other portion of the insulating partition 8, thereby mounting the high-voltage busbar bracket 415 on the insulating partition 8.

Optionally, the high-voltage output busbar 414 includes a copper busbar.

Optionally, the high-voltage busbar bracket 415 includes a plastic bracket.

Specifically, during assembly, the high-voltage output busbar 414 is mounted on the insulating partition 8 by means of the high-voltage busbar bracket 415, and the connection end of the high-voltage output busbar 414 is welded and fixed on the high-voltage output terminal tab 17. The insulating partition 8 provides support for the high-voltage output busbar 414 to facilitate the welding operation of welding the high-voltage output busbar 414 and the high-voltage output terminal tab 17. After the connection end of the high-voltage output busbar 414 is welded and fixed on the high-voltage output terminal tab 17, the output end of the high-voltage output busbar 414 is further connected and fixed on the high-voltage output terminal base 416 on the connection beam 2. The high-voltage output busbar 414, supported and fixed by the insulating partition 8, is connected to the high-voltage output terminal base 416, which is supported and fixed by the connection beam 2, such that neither the high-voltage output terminal base 416 nor the high-voltage output busbar 414 readily wobbles or experiences positional deviation, thereby ensuring stability when the output end of the high-voltage output busbar 414 is connected and fixed.

In the foregoing embodiment of the battery module, the output end of the high-voltage output busbar 414 and the output end of the low-voltage output busbar 406 are respectively connected to the two connection beams 2, which is conducive to the stability of the arrangement of the output ends of the high-voltage output busbar 414 and the low-voltage output busbar 406, thereby facilitating stable high-voltage and low-voltage output from the cell stack 1.

Referring to FIGS. 3-8, in some optional embodiments, some of the two cell stacks 1 adjacent to each other are provided with second connection terminal tabs 14. The electrical assembly includes a first bracket 407 and a second connection busbar 408. The first bracket 407 is positioned and assembled on the side panel assembly 3. The second connection busbar 408 is mounted on the first bracket 407 and connected to the second connection terminal tab 14, and the second connection busbar 408 is connected to another one of the second connection busbar 408 that is connected to an adjacent one of the cell stacks 1.

Optionally, the second connection busbar 408 includes a copper busbar.

Optionally, the first bracket 407 includes a plastic bracket.

Optionally, the electrical assembly further includes a connection terminal base 409. The connection terminal base 409 is mounted on the connection beam 2. The second connection busbar 408 connected to the adjacent ends of the two cell stacks 1 adjacent to each other is fixed on and connected to the connection terminal base 409 so as to realize series and/or parallel interconnection between the two cell stacks 1 adjacent to each other. Further, a first mounting groove 21 is provided at the top of the connection beam 2, the connection terminal base 409 is snap-fitted and secured to the first mounting groove 21, and two second connection busbars 408 connected to the two cell stacks 1 adjacent to each other are bent toward one another and overlapped on the connection terminal base 409, and are secured by a fifth locking member 75, wherein the fifth locking member 75 includes a bolt.

Specifically, during assembly, the connection terminal base 409 is fixed on the connection beam 2, and the second connection busbar 408 is fixed on the side panel segment 31 by the first bracket 407. After the side panel segment 31 and the connection beam 2 are assembled in place, the second connection busbar 408 is welded and fixed on the second connection terminal tab 14 of the cell stack 1. The second connection busbar 408, supported and fixed by the side panel segment 31, is connected to the connection terminal base 409, which is supported and fixed by the connection beam 2. The connection terminal base 409 and the second connection busbar 408 are resistant to wobble and positional deviation, thereby ensuring stability when the second connection busbar 408 and the connection terminal base 409 are joined by the fifth locking member 75.

In the foregoing embodiment of the battery module, the connection terminal base 409 and the first bracket 407 connected to the second connection busbar 408 are fixed on the connection beam 2 and the side panel segment 31, respectively. The connection beam 2 and the side panel segment 31 thereby respectively provide support for the connection terminal base 409 and the second connection busbar 408, rendering the connection terminal base 409 and the second connection busbar 408 resistant to positional deviation, providing structural stability, and facilitating the series and/or parallel interconnection between cell stacks 1.

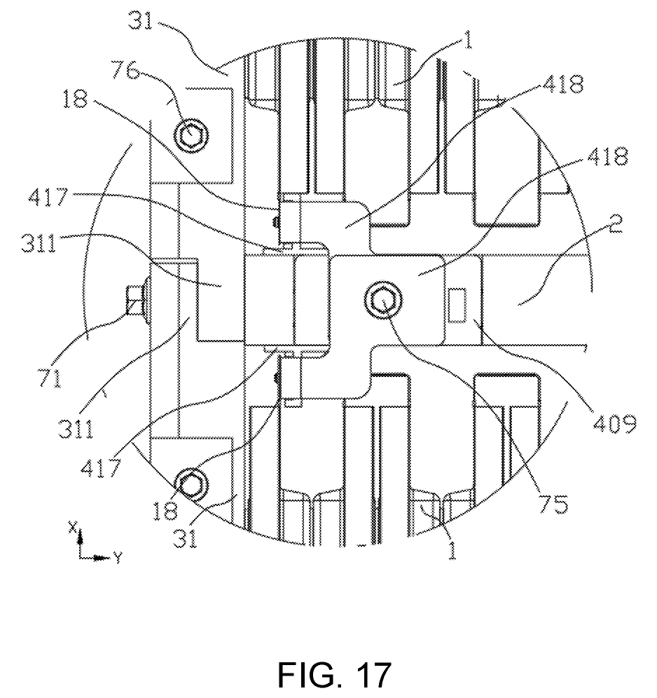

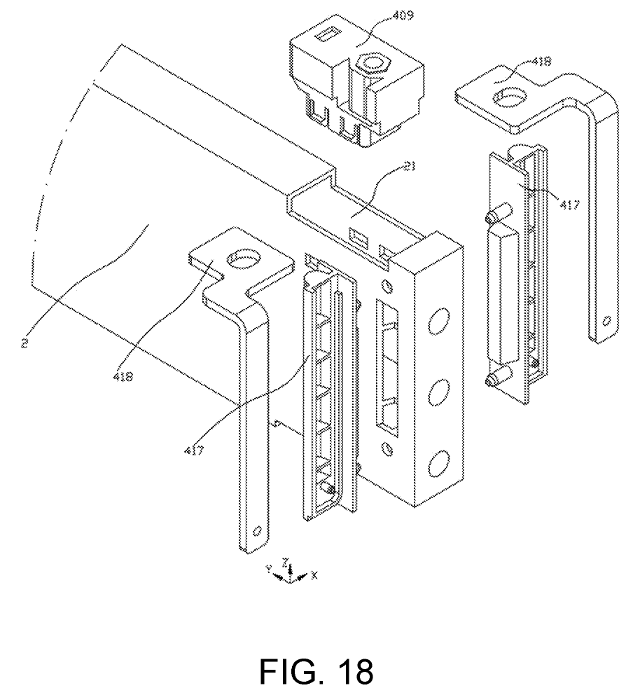

Referring to FIGS. 17 and 18, in some optional embodiments, some of the two cell stacks 1 adjacent to each other are provided with third connection terminal tabs 18. The electrical assembly includes a second bracket 417 and a third connection busbar 418. The second bracket 417 is located between the cell stack 1 and the connection beam 2 and is mounted on the connection beam 2. The third connection busbar 418 is fixed on the second bracket 417 and is connected to the third connection terminal tab 18, and the third connection busbar 418 is further connected to another one of the third connection busbar 418 connected to an adjacent one of the cell stacks 1.

Optionally, the third connection busbar 418 includes a copper busbar.

Optionally, the second bracket 417 includes a plastic bracket. Furthermore, the second bracket 417 is secured to the connection beam 2 by riveting and/or press-fitting, resulting in a simple, convenient, and reliable connection.

Optionally, the electrical assembly further includes the connection terminal base 409. The connection terminal base 409 is fixed on the connection beam 2. The third connection busbar 418 connected to the adjacent ends of the two cell stacks 1 adjacent to each other is secured to the connection terminal base 409 by the fifth locking member 75. The connection terminal base 409 is snap-fitted and secured to the connection beam 2, and the fifth locking member 75 includes a bolt. Further, the first mounting groove 21 is provided at the top of the connection beam 2, and the connection terminal base 409 is snap-fitted and secured to the first mounting groove 21, thereby providing a simple and convenient connection.

In the foregoing embodiment of the battery module, the second bracket 417 is connected to the connection beam 2 in a simple, convenient, and reliable manner. The connection beam 2 provides stable support and positioning for the second bracket 417, thereby reducing the likelihood of offset of the third connection busbar 418, which is conducive to lowering assembly difficulty and improving assembly quality.

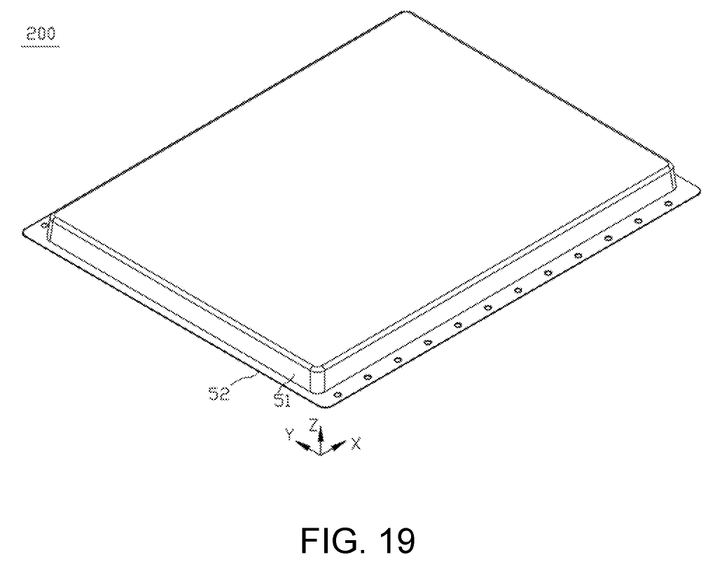

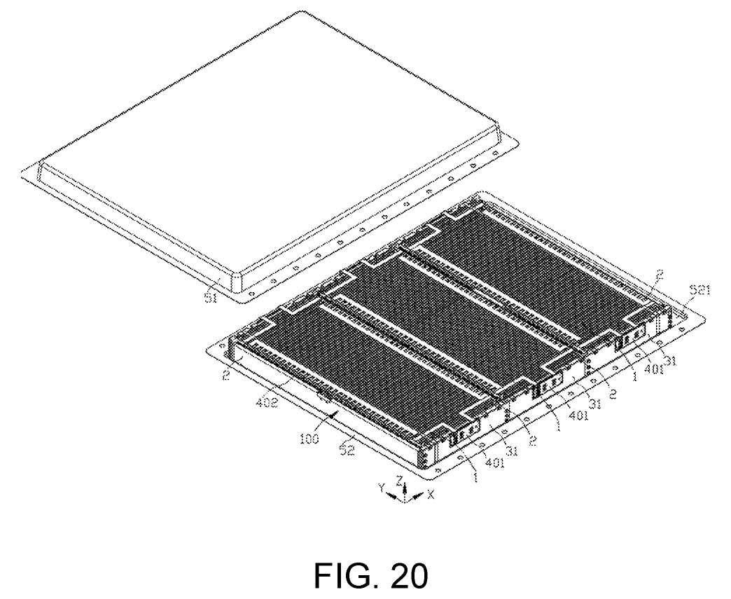

Referring to FIGS. 1, 2, 19, and 20, in some optional embodiments, the present disclosure also provides a battery pack 200, including the battery module 100 in any of the above embodiments and a plate-shaped lower casing 52. The side panel assembly 3 is connected to the lower casing 52 to mount the cell stack 1 on the lower casing 52.

Optionally, a portion of the lower casing 52 protrudes in a direction away from the battery module 100 to form an accommodating cavity 521, and the battery module 100 is mounted within the accommodating cavity 521.

Optionally, the side panel assembly 3 may be connected and secured to the lower casing 52 by a sixth locking member 76, and the sixth locking member 76 includes a bolt.

Optionally, the battery pack 200 further includes an upper lid 51. The upper lid 51 is connected with the lower casing 52 in a sealed manner to define the mounting space accommodating the cell stack 1, and the mounting space is filled with a coolant that submerges the cell stack 1. Further, an inlet and an outlet are provided on an enclosure defined by the connection between the upper lid 51 and the lower casing 52. The coolant is filled into the mounting space through the inlet until the coolant flows out of the outlet, so that the mounting space is completely filled with the coolant and the cell stack 1 within the mounting space is fully submerged in the coolant, thereby implementing immersion cooling with favourable cooling performance.

Optionally, one battery module 100 is provided in the battery pack 200. The assembled battery module 100 may be directly loaded into the lower casing 52 of the battery pack 200, thereby simplifying subsequent in-box installation steps; installation is simple and efficient.

During assembly, the side panel segment 31 of the side panel assembly 3 is connected with the connection beam 2 to clamp and secure the corresponding cell stack 1. The electrical assembly is integrally fixed on a frame formed by the side panel assembly 3 and the connection beam 2. The assembled battery module 100 is mounted on the lower casing 52, the upper lid 51 is installed, the upper lid 51 is connected with the lower casing 52 in a sealed manner to define the mounting space, the mounting space is filled with the coolant, and the coolant submerges the cell stack 1 to implement immersion cooling, thereby completing final assembly.

In the battery pack of the foregoing embodiments, the side panel assembly 3 and the connection beam 2 in the battery module cooperate to clamp and secure the cell stack 1, such that no additional beam structures are required on the periphery of the plate-shaped lower casing 52 to fasten the cell stack 1, which is conducive to structural simplification, weight reduction, and cost reduction. In addition, the electrical assembly is integrated on the frame formed by the side panel assembly 3 and the connection beam 2. After assembly of the battery module 100 is completed, the battery module 100 may be directly installed on the lower casing 52 of the battery pack 200, obviating the need to individually install the cell stack 1 and electrical assemblies such as the slave panel 401 inside the lower casing 52, thereby providing a simple structure and simple and convenient installation operation, and facilitating simplification of in-box installation steps.

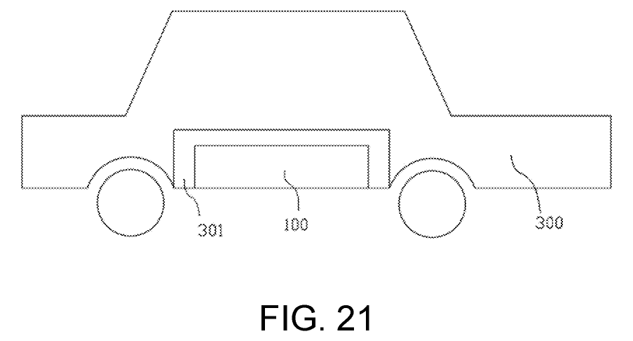

With reference to FIG. 21, in some optional embodiments, the present disclosure further provides an electrical device including the battery module 100 in any of the foregoing embodiments.

Optionally, the electrical device includes a vehicle 300. A mounting space 301 is provided at a bottom of the vehicle 300, and the battery module 100 is mounted in the mounting space 301 to form a power supply module of the vehicle. Further, the vehicle 300 has a chassis provided with the mounting space 301. The battery module 100 may be connected to the chassis such that the battery module 100 is directly disposed in the mounting space 301 of the chassis, resulting in a simple structure and compact layout, thereby improving space utilization.

Optionally, one battery module 100 is provided in the electrical device. The assembled battery module 100 may be directly loaded into the mounting space 301 of the electrical device. The overall structure of the battery module 100 requires no secondary assembly, thereby simplifying subsequent installation steps and enabling simple and efficient installation.

In the battery module, the battery pack, and the electrical device of the present disclosure, the side panel assembly 3 and the connection beam 2 cooperate to provide a preload to fasten a plurality of cell stacks 1, such that the side panel assembly 3, the connection beam 2, and the plurality of cell stacks 1 form an integral unit, which improves overall structural rigidity and meets transportation requirements under a compressed/preloaded condition. Meanwhile, the electrical assembly is integrally fixed on the side panel assembly 3 and/or the connection beam 2, thereby increasing the degree of integration of the overall structure and, while meeting transportation requirements, simplifying subsequent overall enclosure installation steps, which is conducive to improving production efficiency.

In the description of the present specification, references to the terms “embodiment,” “example,” “specific example,” and the like indicate that a particular feature, structure, material, or characteristic described in connection with the embodiment or example is included in at least one embodiment or example of the present disclosure. The illustrative use of the foregoing terms in this specification does not necessarily refer to the same embodiment or example. Moreover, the specific features, structures, materials, or characteristics described may be combined in any suitable manner in one or more embodiments or examples.

The foregoing embodiments are provided solely for illustrative purposes to explain the principles and advantages of the present disclosure and are not intended to limit the present disclosure. Any person skilled in the art may make modifications or alterations to the foregoing embodiments without departing from the spirit and scope of the present disclosure. Accordingly, all equivalent modifications or alterations made by those of ordinary skill in the art without departing from the spirit and technical concept disclosed herein are intended to be encompassed within the scope of protection defined by the claims of the present disclosure.

What is claimed is:

1. A battery module, comprising:
a plurality of cell stacks, the plurality of cell stacks being arranged along a first direction, each of the cell stacks comprising a plurality of cells stacked along a second direction, the cells comprising pouch cells;
connection beams, any two of the cell stacks adjacent to each other being provided with one of the connection beams;
two side panel assemblies, the two side panel assemblies being disposed, along the second direction, on both sides of the cell stacks, the side panel assemblies being connected to the connection beams to clamp and secure the cell stacks;
an electrical assembly, integrally fixed on at least one kind of the connection beams and the side panel assemblies.

2. The battery module according to claim 1, wherein each of the side panel assemblies comprises a plurality of side panel segments distributed along the first direction and detachably connected, the side panel segments located on both sides of a same cell stack are detachably connected, respectively, to both ends of the corresponding connection beams.

3. The battery module according to claim 2, wherein the plurality of side panel segments of the same side panel assembly correspond to the plurality of cell stacks one by one, the two side panel segments located on both sides of the cell stack, when connected to the connection beams, clamp and secure the cell stack along the second direction.

4. The battery module according to claim 2, wherein each of the side panel segments has a first connection portion, two of the adjacent first connection portions of two of the adjacent side panel segments in the same side panel assembly are stacked along the second direction and are connected to and tightly engaged with the connection beams.

5. The battery module according to claim 4, wherein one of the two first connection portions that are stacked has a cross-section that is L-shaped, and the other one of the first connection portions has a cross-section that is an inverted L-shape that is complementary to and in surface contact with the L-shaped structure.

6. The battery module according to claim 1, wherein the electrical assembly comprises a battery management system and sampling elements, the battery management system comprises a plurality of slave panels, the plurality of slave panels are mounted and fixed on the side panel assemblies and are electrically connected, respectively, to the plurality of cell stacks via the sampling elements.

7. The battery module according to claim 6, wherein each of the side panel assemblies comprises a plurality of side panel segments distributed along the first direction and detachably connected, the plurality of side panel segments within the same side panel assembly respectively correspond to the cell stacks one by one, the slave panel is mounted on each of the side panel segments, and the slave panel is electrically connected to the corresponding cell stack via the sampling element.

8. The battery module according to claim 6, wherein a groove is provided on the side panel assembly, the slave panel is mounted within the groove, and an outer wall of the slave panel is lower than, or aligned with, an opening of the groove.

9. The battery module according to claim 8, wherein the groove is provided on an exterior of the side panel assembly facing away from the cell stack, and extends along a third direction so as to run through a top end of the side panel assembly, a top end of the slave panel does not protrude beyond the top end of the side panel assembly, and a side wall of the slave panel does not protrude beyond an outer side wall of the side panel assembly.

10. The battery module according to claim 6, wherein the slave panel is fixed on the side panel assembly by snap-fit engagement or by bolted connection.

11. The battery module according to claim 1, wherein some of the two cell stacks adjacent to each other are provided with first connection terminal tabs, the electrical assembly comprises a bridging busbar and a first connection busbar, the first connection busbar is connected to the first connection terminal tab, the first connection busbars respectively connected to the corresponding first connection terminal tabs of the two cell stacks adjacent to each other are offset in projection along the first direction, and are interconnected by the bridging busbar and fixed on the connection beam.

12. The battery module according to claim 1, wherein some of the cell stacks are provided with low-voltage output terminal tabs, the electrical assembly comprises a low-voltage busbar bracket and a low-voltage output busbar, the low-voltage busbar bracket is positioned and assembled on the side panel assembly, and the low-voltage output busbar is mounted on the low-voltage busbar bracket and connected to one of the low-voltage output terminal tabs.

13. The battery module according to claim 12, wherein some of the cell stacks are provided with high-voltage output terminal tabs, the electrical assembly comprises a high-voltage busbar bracket and a high-voltage output busbar, the high-voltage output busbar is mounted on the high-voltage busbar bracket, and a connection end of the high-voltage output busbar is connected to the corresponding one of the high-voltage output terminal tabs.

14. The battery module according to claim 13, wherein the low-voltage output busbar and the high-voltage output busbar are respectively disposed on both sides of the battery module in the first direction, the high-voltage output busbar is adapted to output a high voltage and the low-voltage output busbar is adapted to output a low voltage.

15. The battery module according to claim 14, wherein the connection beam formed as an end beam is disposed on a side of the cell stack located at an edge side that is away from a cell stack adjacent thereto, the connection beam is connected to an end portion of the side panel assembly, the high-voltage output busbar and the low-voltage output busbar are respectively connected to, and electrically insulated from, two of the connection beams on both sides.

16. The battery module according to claim 1, wherein some of the two cell stacks adjacent to each other are provided with second connection terminal tabs, the electrical assembly comprises a first bracket and a second connection busbar, and the first bracket is positioned and mounted on the side panel assembly, the second connection busbar is mounted on the first bracket and connected to the second connection terminal tab, and the second connection busbar is connected to another one of the second connection busbar that is connected to an adjacent one of the cell stacks.

17. The battery module according to claim 1, wherein some of the two cell stacks adjacent to each other are provided with third connection terminal tabs, the electrical assembly comprises a second bracket and a third connection busbar, and the second bracket is located between the cell stack and the connection beam and mounted on the connection beam, the third connection busbar is secured on the second bracket and connected to the third connection terminal tab, and the third connection busbar is connected to another one of the third connection busbar that is connected to an adjacent one of the cell stacks.

18. The battery module according to claim 1, wherein the connection beam formed as an end beam is disposed on a side of the cell stack located at an edge side that is away from the cell stack adjacent thereto, end portions of the two side panel assemblies are connected to each other via the end beam; and
the end portions of the two side panel assemblies are wrapped and fastened together by a strap.

19. A battery pack, comprising the battery module according to claim 1 and a plate-shaped lower casing, wherein the side panel assembly is connected to the lower casing to mount the cell stack on the lower casing, the battery pack further comprises an upper lid, the upper lid is connected to the lower casing in a sealed manner to define a mounting space accommodating the cell stack, and the mounting space is filled with a coolant that submerges the cell stack, a portion of the lower casing is raised in a direction facing away from the battery module to form an accommodating cavity, and the battery module is mounted in the accommodating cavity.

20. An electrical device, comprising the battery module according to claim 1, wherein the electrical device comprises a vehicle, a bottom portion of the vehicle has a mounting space, and the battery module is mounted within the mounting space.
